(19) United States
(12) Patent Application Publication
(10) Pub. No.: US 2014/0026479 A1
(43) Pub. Date: Jan. 30, 2014

(54) Vermicomposting Growing System

(71) Applicant: Hernan Almeida, Chicago, IL (US)

(72) Inventor: Hernan Almeida, Chicago, IL (US)

(21) Appl. No.: 13/561,876

(22) Filed: Jul. 30, 2012

(51) Int. Cl. A01G 9/02

(52) U.S. Cl. 47/65.5

(57) ABSTRACT

Vermicomposing Composing system is a product that delivers and age-old way to cultivate the most natural and healthiest vegetables and fruits either at home or commercially for a low cost without the use of any chemicals or fertilizers. This product incorporates red worms and compost matter to produce a waste high in nutrients. This waste works as a fertilizer for the vegetable or fruit plant growing within the base of the system. This whole process happens within one planting unit, which will require approximately 14 square inches of space.

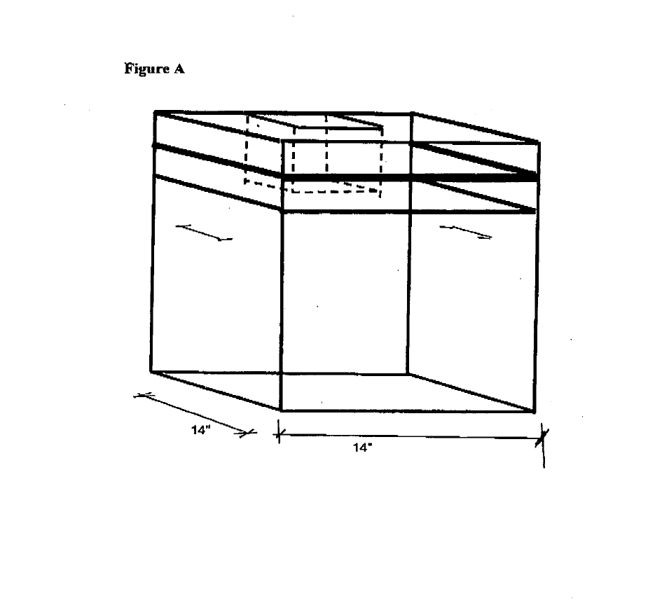

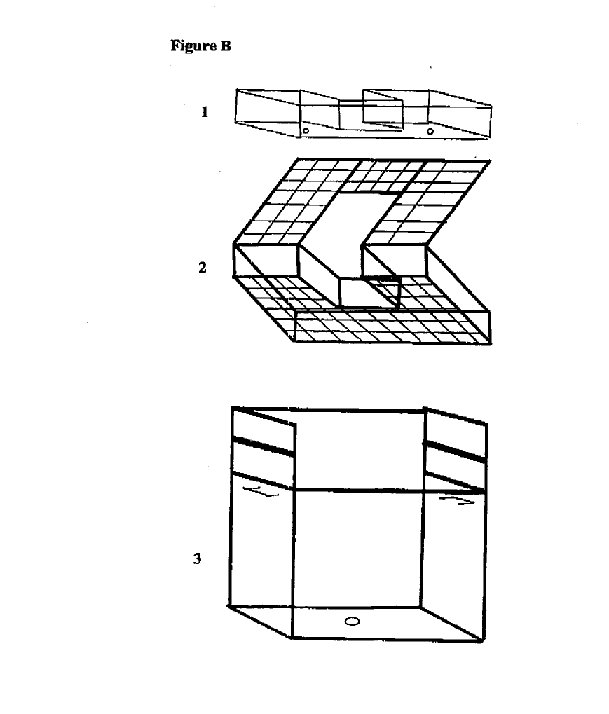

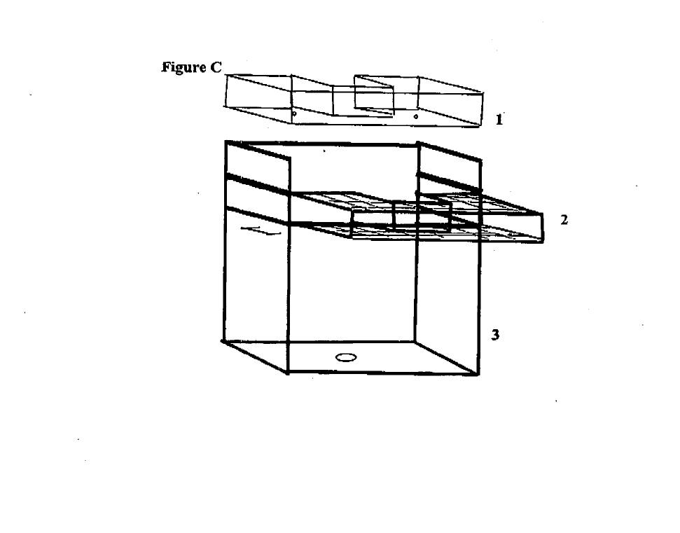

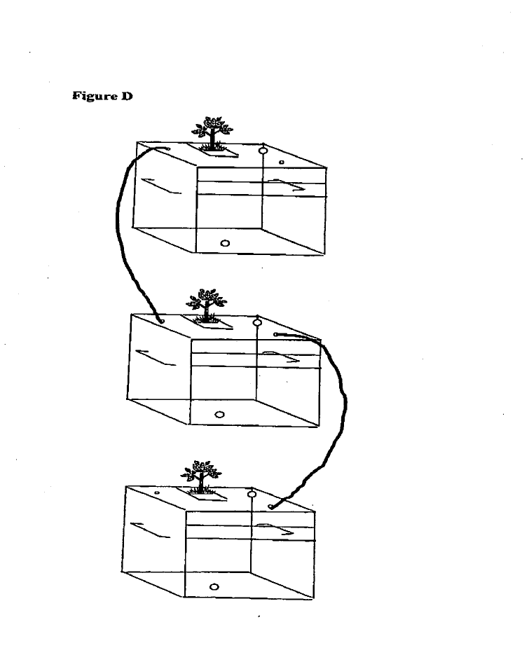

### BACKGROUND

Vermicomposting is the process of using earthworms to turn organic wastes into high quality compost which is what this system is all about.

This utility has been designed to organically produce many vegetables in their natural habitat as well as to help prevent the loss of plants due to lack of water or plant infection. We all know the use of chemicals in pesticides and fertilizers will have negative effects on the health of our society in time. This utility will help to minimize these problems.

### SUMMARY

The systems base is similar to a pot, like those already used today for planting. The pot requires regular soil were the vegetable will be planted. A feeding bed is positioned on top of the soil, which will be filled with organic waste to serve as food for the worms. A watering tank sits on top of the feeding bed. Both the feeding bed and watering tank are specially designed with a ‘U’ shape that allows you to remove either the feeding bed, watering tank, or both pieces without causing damage to the plant. These systems are designed for residential and a greenhouse setting.

### DESCRIPTION

The watering tank will provide continuous moisture to the soil as well as the worms. Located on the bottom side of the watering tank are two tiny holes, one on each side. These holes will constantly drip water at a slow pace providing a great environment for the worms while moving the fertilizer (worm castings and decomposed organic matter) from the feeding bed to the base of the system to feed and hydrate the roots of the vegetable. On the topside of each watering tank there are three holes. Two holes are approximately one quarter of an inch in diameter; this is where rubber hoses have the option of being connected. These holes can be covered if the system is working solo. The tanks third hole is approximately one half of an inch in diameter, this hole is for the main water source. These watering tanks are designed to have the option of being connected together via rubber hoses. By connecting each system to another via rubber hose and then attaching one to a direct water source to the main enter, you will never have to spend time watering each plant or have the concern of over watering or under watering your plants.

Underneath the watering tank is a drawer also known as the feeding bed. This drawer will be easy to access by pulling the handle horizontally towards oneself. This is where organic waste and worms must be placed. The organic waste, such as vegetable and fruit waste will serve as food for the worms. The feeding bed also has a cover. The cover will open from the front in an upward motion, but remain attached to the back by a hinge. The feeding bed has holes on the top and bottom sides, similar to a strainer, which allows the worms and water to pass through to the base where the plant is. Also, the inside cover of the feeding bed is lined with fabric. This fabric retains and holds water and allows the water to pass through to the inside of the feeding bed which helps with temperature and moisture control.

The ‘U’ shape, which is my claim, allows you to remove the drawer (feeding bed) and then open and close it to feed the worms when needed without harming the plant. The watering tank also has this ‘U’ design. Not for the sole purpose of removal but also so the plant can continue to have room to grow while receiving continuous moisture.

### DESCRIPTION OF DRAWINGS

Figure A: shows the entire system already assembled.

Figure B: shows all the parts of the system; (1) watering tank, (2) feeding bed and (3) base of the frame. The watering tank has two holes on the underside, one on each side. These holes allow water to drip continuously. The continuous dripping water and fabric provide proper moisture control needed for the possibility of high outdoor temperatures that could be harmful to the worms. Fabric is attached to the inside cover of the feeding bed, where the worms and organic food waste will be placed. When the feeding bed is removed from the frame, the top of the feeding bed opens from the front using a hinge like motion. This is where organic waste is stored as a source of food for the worms and nutrients for the plant. The feeding bed has many holes on the top and bottom sides. These holes allow water and nutrients from organic waste to pass through the feeding bed down to the rooting system within the frame. Also, these holes allow the earthworms to travel from the feeding bed down to the frame giving oxygen to the dirt and rooting system.

Figure C: shows all parts and assemble process. The watering tank (1) is attached to the frame at the very top of the system. The feeding bed (2) is attached to the frame, below the watering tank and on top of the base. The base of the frame (3) is where regular soil will be place and the vegetable plant will be planted. All compartments are made of special plastic that is resistant to hot and cold temperatures.

Figure D: shows, an example plant in all units how the system can be connected together allowing water to move from one tank to another, creating a chain of systems.

1. An organic planting and composting system made of plastic, which includes a watering tank and feeding bed that aid in the production of vegetables or fruit high in nutrients that are 100% organic without the use of chemical fertilizers or pesticides.

2. The method of claim 1, wherein the watering tank has a U design that allows the plant to continue to grow while continuously staying hydrated.

3. The method of claim 1, wherein the feeding bed has a U design that allows the plant to continue to grow while organic waste decomposes above the dirt of the system while continuously providing organic nutrients to the rooting system.

4. The method of claim 1, wherein the fabric lining the inside cover of the feeding bed has a U design that allows the plant to continue to grow while the compost and worms within the feeding bed stays properly hydrated.

5. The method of claim 1, wherein the system requires the use of red worms to aid in the decomposition processes of organic waste within feeding bed.
